(19) United States
(12) Patent Application Publication
(10) Pub. No.: US 2022/0104647 A1
(43) Pub. Date: Apr. 7, 2022

(54) Floor Covering Element

(71) Applicant: Martina Grünewald, Wien (AT)

(72) Inventor: Martina Grünewald, Wien (AT)

(21) Appl. No.: 17/429,325

(22) PCT Filed: Nov. 14, 2019
(86) PCT No.: PCT/AT2019/060389

§ 371 Date: Aug. 6, 2021

(30) Foreign Application Priority Data
Feb. 18, 2019 (AT) A50120/2019

(51) Int. Cl. A47G 27/02; B32B 5/02; B32B 7/12; B32B 5/26; B32B 5/08; E04F 15/16

(52) U.S. Cl. CPC A47G 27/0243; B32B 2307/744; B32B 7/12; B32B 5/262; B32B 5/08; E04F 15/16; A47G 27/0212; B32B 2471/00; B32B 2307/304; B32B 2255/02; B32B 2307/732; B32B 2307/718; B32B 2255/26; B32B 2255/24; B32B 2307/536; B32B 2262/14; B32B 2262/0276; B32B 2262/0246; B32B 2262/101; B32B 2262/062; B32B 2307/102; B32B 2307/3065; B32B 2250/20; B32B 2255/20; B32B 2255/28; B32B 2262/065; B32B 2307/412; B32B 2307/538; B32B 2307/584; B32B 5/024

(57) ABSTRACT

The invention relates to a floor covering element comprising an insulation layer (1) facing the floor when laid, a backing layer (2) of canvas, provided on the insulation layer (1) and connected to said insulation layer (1), at least the upper face of the backing layer (2) being coated with a primer (3a), wherein a primed layer (4) for at least partially optically designing the floor covering is applied to the primer (3a) on the upper face; and a transparent sealing coat (5) is provided on the printed layer (4), the surface structure of the sealing coat (5) being predetermined by the backing layer (2) of canvas and having a surface roughness (8a) of at least 7.5 μm, in particular at least 8.0 μm, preferably at least 9.4 μm.

The invention relates to a printed, multilayer floor covering element.

Floor covering elements are used, among other things, to provide heat and impact sound insulation, to protect the floor from wear and tear, and to enable the individual design of interiors. In order to create a warm, homely atmosphere, the haptic properties of the floor covering element are also important, since smooth surfaces appear cold and rough materials are easily perceived as scratchy. At the same time, the floor covering element should have a non-slip surface and be as easy to clean as possible. At the end of the product's life,a floor covering element should be reusable or recyclable to avoid generating large quantities of waste to be disposed of.

A wide variety of floor covering elements, such as carpets or floor mats, are known from the prior art. On the one hand, carpets made of fiber materials with piles and loops of different thicknesses are well-known, such as ‘oriental carpets,’ or flat-woven carpets, such as ‘rag rugs.’ These have good insulation properties and create a warm atmosphere. However, carpets get dirty quickly and are difficult to clean, as dirt can usually only be removed locally through vigorous dabbing, or they must be cleaned professionally due to their material composition, which is associated with a high monetary outlay while taking a long time.

On the other hand, flooring that can be placed freely or laid flat, is made of vinyl, PVC and linoleum is also well-known. Due to the manufacturing process, such floor coverings, which can be wiped clean with a damp cloth, are severely limited in their individual design possibilities. Even well-known functional mats with a multilayer structure do not meet the need for a combination of high-quality functional, aesthetic and haptic properties, and their material and assembly properties mean they can rarely be recycled, or they cannot be recycled at all.

DE 202015004860 U1 shows, for example, a floor mat with an adhesive layer for sticking to a floor, a design element and a non-slip surface element, wherein the non-slip effect is achieved by laminating or embossing. Such surfaces have a tendency to become soiled when in constant use. The surface element severely restricts individual design freedom, since the design element is not clearly visible but, due to the lamination or embossing, the color quality is impaired and the boundaries are only indistinctly discernible. Furthermore, the haptic properties are not suitable for creating a warm atmosphere and any insulation effect is missing.

Well-known floor covering elements can therefore not meet all the requirements placed on them.

The task of the invention is therefore to provide a floor covering element that has heat and impact sound insulation, is slip-resistant, easy to clean, in particular can be wiped clean with a damp cloth and can be individually designed and has a pleasant feel.

The invention solves the problem by providing a floor covering element comprising, in use, an insulation layer facing the floor when laid, a backing layer of canvas, provided on the insulation layer and connected to said insulation layer, at least the upper face of the backing layer being coated with a primer, wherein: a printed layer for at least partially optically designing the floor covering is applied to the primer on the upper face; and a transparent sealing coat is provided on the printed layer, the surface structure of the sealing coat being predetermined by the backing layer of canvas and having a surface roughness (Sa) of at least 7.5 μm, in particular at least 8.0 μm, preferably at least 9.4 μm.

The design according to the invention allows the requirements for a floor covering to be met. On the one hand, the insulation layer provides heat and impact sound insulation. In addition, it can prevent the canvas from being deformed by use or bumps and crumbs that get under the floor covering element, and such deformations causing damage to the sealing coat under further loads.

The primer protects the canvas from moisture damage, such as deformation. In addition, the primer enables a sharp printed image, which is visible through the transparent sealing coat. This allows the floor covering element to be customized. The sealing coat is water- and dirt- repellent and allows for easy cleaning, as the floor covering element can be wiped clean with a damp cloth. The surface roughness provided by the canvas does not affect the cleaning process. In addition, this can provide a non-slip surface with pleasant haptic properties.

The design according to the invention also allows the floor covering element to be rolled up and is thus easy to transport without compromising functionality. This allows for particularly flexible use.

Canvas is a tightly woven fabric made from strong yarn and is made from natural fibers such as plant fibers, preferably cotton, hemp, linen, banana fibers, or mineral fibers, or preferably silicate glass fibers. Fabrics made of various natural fibers can also be used. It is also possible to manufacture canvas from blended fabrics or blended fibers with polyesters, polyacrylonitrile etc. Pure natural fiber fabrics are preferable due to the better adhesion of the primer and for reasons of sustainability. Canvas is produced in different weaves, e.g. plain weave, half-panama weave, panama weave, or ripstop. Each of these weaves is suitable for the invention and implies the desired surface roughness.

The perception threshold for haptic properties is around 1 μm, i.e. surface structures can be perceived down to this small size. The surface roughness can be determined as an Sa value, wherein the arithmetic mean value of the thickness of the selected surface is determined by light microscopy. The surface roughness (Sa) is determined according to ISO 25178, e.g. with the aid of an Alicona Infinitive Focus Microscope (IFM). The surface roughness according to the invention is found to be particularly pleasant.

Advantageous embodiments result from the following features:

It can be provided that the floor covering element has a thickness between 2 mm and 7 mm, in particular between 2 mm and 5 mm, preferably between 2.5 mm and 4.5 mm. The low thickness makes the floor covering element particularly flexible in use, since it can also be used in the door area without obstructing the opening or closing of a door. The floor covering element can therefore be used both as a flat covering and an exposed, limited floor support. For example, the floor covering element can be used as a table place mat or desk mat. At the same time, its low thickness makes it particularly easy to transport without compromising stability.

In order to obtain a particularly good slip resistance, it can be provided that the backing layer consists of canvas with a weight per square meter of between 350 g/m² and 850 g/m², in particular between 450 g/m² and 800 g/m², preferably between 500 g/m² and 750 g/m². Additionally or instead, the backing layer of canvas may have a thickness of at least 0.6 mm, in particular of at least 0.7 mm, preferably of at least 0.8 mm. This makes it possible to provide a stable floor covering element with a particularly good slip resistance and pleasant haptic properties.

In order to prevent the backing layer from deforming due to the effects of moisture, the backing layer can be coated on both sides with the primer or an underside primer can be applied to the underside of the backing layer facing the insulation layer. The underside primer also improves the bond between the backing layer and the insulation layer, since in the case of a backing layer coated on both sides, the backing layer is bonded to the insulation layer via the underside primer. The underside primer prevents deep penetration of the fastener into the canvas backing layer, so that the insulation layer can be completely detached from the backing layer by pulling it apart forcefully. This is particularly advantageous, since different materials can usually only be recycled separately and thus at the end of the product's life it can still be used or recycled, whereas well-known floor covering elements often have to be disposed of.

It is particularly suitable if the primer consists of acrylic gesso. Additionally or instead, it can be provided that the primer is a coat comprising calcium carbonate and acrylic polymer, and in particular titanium white pigments. On the one hand, such a primer can provide good moisture protection for the canvas backing layer, while the surface roughness is only slightly affected. The primer is also particularly suitable for adhesion of the printed layer and, if necessary, also for bonding with the insulation layer. Furthermore, a particularly clear and sharp printed image can be produced on the primer.

A particularly resistant and stable floor covering element can be obtained if the sealing coat is made of parquet varnish. Additionally or alternatively it can be provided that the sealing coat takes the form of a coat comprising polyurethane acrylate copolymer and/or a polyurethane and/or a polyacrylate. The floor covering element thereby obtains a particularly waterproof, dirt-repellent and easy-to-clean surface, which can be cleaned, for example, by wiping or vacuuming. In addition, a particularly suitable hardness can be achieved to prevent scratches, while at the same time good flexibility can be maintained to prevent the floor covering element from being damaged by cracks when rolled up. Even in the event of damage, such a sealing coat is easy to repair or renew. The same effect can be achieved by sealing with hard wax oil based on natural waxes or oils such as sunflower oil, soybean oil, safflower oil, carnauba wax and candelilla wax, which can be mixed with siccatives and water-repellent additives. This sealing coat has the further advantage of providing a floor covering element made from natural materials.

The sealing coat can preferably have a thickness of 80 μm to 100 μm. On the one hand, this preserves the surface roughness specified by the canvas, while at the same time, depending on the area of application, the stress classes ONORM C 2354 A, B or C (moderate, heavy or particularly heavy stress) can be fulfilled.

In particular, the sealing coat has a surface roughness (Sa) of up to 14 μm, preferably up to 11 μm. This surface roughness allows a particularly good non-slip effect with easy cleaning and good stability. In addition, the surface roughness is found to be particularly pleasant and non-scratchy.

In order to simplify the use of the floor covering element tor living rooms, in particular for children's rooms, it can be provided that the sealing coat is saliva-proof and acid-resistant.

A particularly clear and sharp printed image can be obtained if the printed layer consists of a latex ink. Additionally or instead, it can be provided that the printed layer takes the form of a coat comprising latex and pigments, and in particular a styrene-acrylate copolymer. These inks are very lightfast and abrasion-resistant. Ink can be prevented from collecting in low spots of the surface structure. On the one hand, the surface roughness is particularly well preserved, and uniform drying is possible. The ink is also odorless and harmless to health. The printed layer can preferably be applied using the digital printing process, so that the individual design is particularly simple and efficient, since a well-known and widely used technology can be used.

In order to obtain a particularly stable floor covering element, it can be provided that the insulation layer has a thickness of 2-5 mm. On the one hand, this thickness allows great flexibility, while at the same time good thermal and impact sound insulation can be achieved. In particular, it can be provided that the insulation layer consists of a, preferably natural, felt, in particular with a hardness of M3 to F3 (DIN 61200). A flame-retardant effect can be achieved by using natural felts, in particular with wool admixtures. In addition, such felts have particularly good insulation properties. This effect is enhanced by the special hardness. In addition, floor unevenness is compensated for particularly well, and wrinkles during use can be avoided. In this way, the load on the sealing coat can be reduced and the durability of the floor covering element can be improved.

To further increase the durability of the floor covering element, it can be provided that the insulation layer is bonded to the backing layer, preferably in a flat manner. In the case of a backing layer coated on both sides, the backing layer is bonded to the insulation layer above the underside primer. The bonding prevents moisture from penetrating into the floor covering element. It also makes the floor covering element particularly stable. The surface roughness of the backing layer serves as a mechanical anchor, the mass of which, in case of a mechanical pressure load from above, e.g. due to walking on the floor covering element, increases the stability of the bonding by pressing on the adhesive surface underneath, since loosening of the bonding by means of diametrical displacement of the layers through mechanical force effect is prevented due to masses ‘sunken’ into the adhesive rubberized by drying.

Additionally or alternatively, it can be provided that the insulation layer is completely separable from the backing layer, so that further use or recycling at the end of the product's life is simplified. If the carpet's materials are to be recycled, the insulation layer and the backing layer can be separated manually by pulling them apart forcefully. Residual adhesive remains on the insulation layer. This can be further used, for example, as a sealing material. The backing layer can, for example, be provided with a new insulation layer for further use, or it can be sanded down and resealed. Then, for example, it can be used as a table pad, or combined with a new insulation layer, as a heat-insulating wall hanging. At the end of the product's life, the backing layer can be sent for thermal recycling.

Good adhesion with good separability properties at the same time can be obtained if, for bonding between the insulation layer and the backing layer, or the underside primer, an adhesive is applied comprising:
Rubber;
A stabilizer, in particular ammonia, preferably 0.1-0.5 wt. % ammonia; and
A crosslinking system, in particular a fatty acid, preferably lauric acid, and/or a metal oxide, preferably zinc oxide, and/or a thiuram disulfide, preferably tetramethylthiuram disulfide.

The same effect can be achieved if an adhesive comprising natural rubber, rosin glycerol ester, linseed oil, casein, xanthan gum and thiazoles is applied for bonding between the insulation layer and the backing layer, or the underside primer. This special bonding can provide a stable floor covering element that is easily recyclable.

It is also possible to bond the insulation layer to the backing layer or the insulation layer to the underside primer by means of a reactive hotmelt adhesive, for example of polyurethane. This also provides a stable bond, which at the end of the product's life enables separation of the backing layer and the insulation layer.

A particularly advantageous embodiment of the invention is illustrated by the drawing without restricting the general inventive idea.

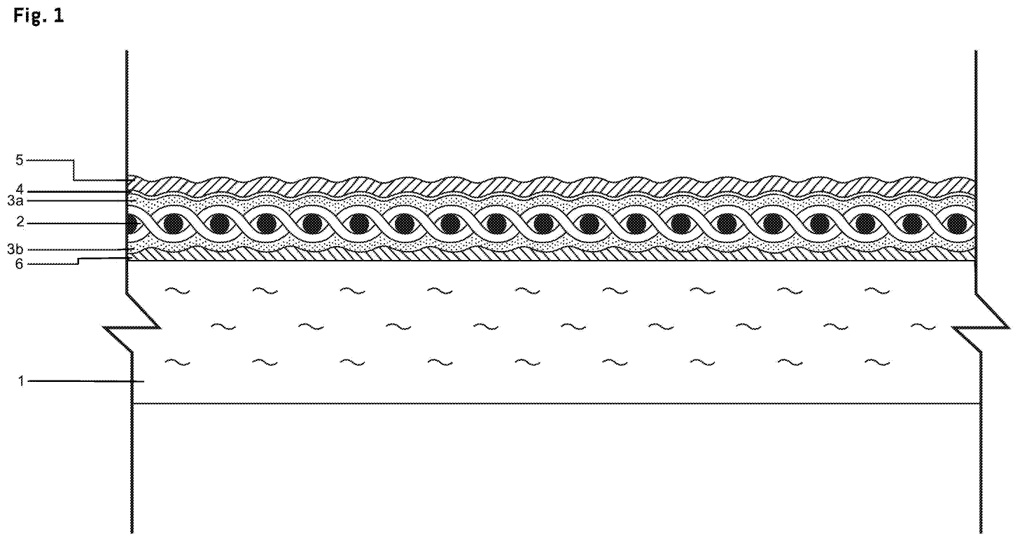

FIG. 1 shows the structure of an example floor covering element according to the invention.

In FIG. 1, a floor covering element is shown with insulation layer 1, which, when used, faces the ground. In the embodiment shown, the insulation layer 1 is made of a wool felt. Alternatively, for example, a wool polyester blend (e.g. 30% wool, 70% polyester) can be also used. Insulation layer 1 is connected with backing layer 2 made of canvas.

In the embodiment shown, insulation layer 1 is connected to backing layer 2 by means of adhesive 6, the adhesive being liquid latex, i.e. an aqueous dispersion of rubber with approx. 0.2% ammonia and a mixture of lauric acid, thiram and zinc oxide. Alternatively, a paste-like adhesive, e.g. based on natural rubber milk, can be used. It is also possible to use another type of bonding, such as adhesive tape.

In the embodiment shown, the canvas is made of untreated cotton yarn woven in plain weave. This has a particularly advantageous surface roughness and is especially easy to coat with the primer. In principle, any other canvas can be used as backing layer 1, e.g. canvas of thicker quality more than 1 mm thick (e.g. #6 number duck or #4 number duck), of an equally dense but coarser weave structure, and/or higher weight (e.g. 610 g/m² or 710 g/m²). Cotton-polyester blends (g. 80% cotton, 20% polyester) etc. can also be used.

In the embodiment shown, backing layer 2 is coated on both sides with primers 3a and 3b. Backing layer 2 therefore has underside primer 3b facing insulation layer 1 and top primer 3a on the opposite side. Primers 3a and 3b comprise calcium carbonate and acrylic polymer and titanium dioxide. Primed backing layer 1 has, in the embodiment shown, a weight of 619 g/m². In another embodiment, when using thicker canvas, for example, #8 may have a weight of 740 g/m² or #6 may have a weight of 820 g/m².

In the embodiment shown, printed layer 4 is placed on top of primer 3a, with the insulation layer 1 facing away from the printed layer 4. In the embodiment shown, printed layer 4 is placed on top of primer 3a to cover the entire surface and is formed by a latex ink.

Printed layer 4 is completely covered by transparent sealing coat 5. In the embodiment shown, sealing coat 5 is of a polyurethane-acrylate copolymer-based composition. In another embodiment, sealing coat 5 can also be based on a composition comprising polyurethane or a composition comprising polyacrylate.

The surface structure of sealing coat 5 is provided by backing layer 2 made of canvas. In the embodiment shown, the seal 5 has a surface roughness (Sa) of 9.4 μm.

An example method for producing a floor covering element according to the invention is shown below:

First, untreated canvas is coated with a primer, preferably coated on both sides by primers 3a and 3b, which creates the backing layer 2. Printed layer 4 is applied to one side of primed backing layer 2, for example using a latex ink in a digital printing process. Sealing coat 5 is applied to all of the upper face of printed layer 4. Backing layer 2 is bonded to insulation layer 1, by applying adhesive 6 to insulation layer 1, preferably in a flat manner, and backing layer 2 is placed in such a way that the sealing coat 5 is placed on the side facing away from insulation layer 1. The application of adhesive 6 between insulation layer 1 and backing layer 2 is independent of the other process steps and can be carried out at any time.

In detail, this can be done as follows:

For a floor covering element according to the invention, backing layer 2 made of canvas is used, wherein the canvas is made of cotton yarn woven in plain weave and has a weight of 514 g/m² and a thickness of 0.8 mm.

By means of calendering, the canvas is coated with acrylic gesso on both sides three times across the whole surface. A conventional acid-free primer with calcium carbonate (CaCO3), acrylic polymer (medium latex) and titanium white is used. Backing layer 2 coated with primers 3a and 3b has a weight of 610 g/m², a thickness of 0.83 mm and an average surface roughness Sa (ISO 25178) of 10.4 μm on both sides.

Coated backing layer 2 is printed on one side, on the upper face, with a decorative motif using well-known latex digital printing technology. In the process inks are used, which are available under the trade name HP 881 Latex Inks. These form a flat printed layer 4, which is placed on the top primer 3a.

For insulation layer 1, a wool felt layer with a thickness of 2 mm (according to DIN 61206), a density of 30 g/ccm (according to DIN 61200), a weight of 600 g/m² (according to DIN 61200) and M5 hardness (according to DIN 61200) is provided. Adhesive 6 is applied to one side of insulation layer 1.

For adhesive 6, a product available under the trade name AURO Floor covering adhesive no. 382 is used, which is applied flat by means of a short hair roller or toothed trowel (fine A3). After a maximum drying time of 20 minutes at a room temperature of 22° C. and an average humidity of 50%, the unprinted underside of the prepared backing layer 2 is placed on insulation layer 1. Underside primer 3b is then placed on the adhesive surface and insulation layer 1 is bonded to backing layer 2 in this way, wherein the layers are bonded together flat by means of a calender under 3-4 bar roll pressure. Backing layer 2 is placed in such a way that printed layer 4 is located on the upper face facing away from insulation layer 1.

The upper face with printed layer 4 is sealed for better durability, wherein a clear parquet varnish is used as sealing coat 5, which is available under the trade name ADLER 42140 ff. Sealing coat 5 is applied with a short hair roller in three coats to an overall dry film thickness of 80-100 μm. For the first coat, 300 g/m² of parquet varnish is used, and 200 g/m² for each of the following coats. The drying time between the individual coats is at least 30 minutes at a room temperature of 22° C. and a humidity of 50%.

After two coats, intermediate sanding with grit 400 sandpaper is possible. Alternatively, sealing coat 5 can be applied by means of Airless or Airmix spraying (0.28-0.33 mm nozzle, 100-120 bar/1-2 bar, approx. 30 s) or compressed air spraying (1.8 mm nozzle, 3-4 bar, approx. 20 s) in a coating chamber or as a core element of an enclosed, automated coating system. Sealing coat 5 can also be applied, for example, before the bonding with insulation layer 1.

After a final drying time of eight days, the floor covering element is waterproof, abrasion-resistant (ÖNORM C 2354 category C, very heavy duty) and sealed according to ÖNORM S 1555 and DIN 53160 to be resistant to sweat and saliva. The floor covering element has an average surface roughness of 9.4 μm and a total thickness of 3,000 μm. The floor covering element can be cut to the desired dimensions.

The edges can be designed individually (e.g. hem seam, bias tape, fold, chain stitch, end stitch, or trimmed flush with the space). For example, the edges can be finished with a tricot stitch or triple zigzag stitch. A particularly robust industrial sewing thread made of

What is claimed is:

1. A floor covering element comprising, in use:
an insulation layer (1) facing a floor when laid;
a backing layer (2) of canvas, provided on the insulation layer (i) and connected to the insulation layer (i), at least an upper face of the backing layer (2) being coated with a primer (3a);
a printed layer (4) for at least partially optically designing the floor covering applied to an upper face of the primer (3a); and
a transparent sealing coat (5) provided on the printed layer (4), a surface structure of the sealing coat (5) being predetermined by the backing layer (2) of canvas, and the surface structure having a surface roughness (Sa) of at least 7.5 μm.

2. The floor covering element according to claim 1, characterized in that the floor covering element has a thickness between 2 mm and 7 mm.

3. The floor covering element according to claim 1, characterized in that the backing layer (2) consists of canvas having a weight per square meter of between 350 g/m² and 850 g/m² and with a thickness of at least 0.6 mm.

4. The floor covering element according to claim 1, characterized in that the backing layer (2) is coated on both sides with the primer (3a, 3b).

5. The floor covering element according to claim 1, characterized in that the primer (3a, 3b) consists of acrylic gesso.

6. The floor covering element according to claim 1, characterized in that the sealing coat (5) consists of.

7. The floor covering element according to claim 1, characterized in that, that the sealing coat (5) comprises natural hard wax oils based on sunflower oil, safflower oil, carnauba wax and candelilla wax and further comprises at least one of siccatives or water-repellent additives.

8. The floor covering element according to claim 1, characterized in that the printed layer (4) consists of a latex ink and pigments that include a styrene-acrylate copolymer.

9. The floor covering element according to claim 1, characterized in that the insulation layer (i) has a thickness of 2 mm to 5 mm, wherein the insulation layer (1) consists of a preferably natural felt with a hardness of M₃ to F₃ (DIN 61200).

10. The floor covering element according to claim 1, characterized in that the insulation layer (1) can be completely separated from the backing layer (2) or the primer (3b) disposed on an underside of satheid backing layer (2).

11. The floor covering element according to claim 1, characterized in that for bonding between the insulation layer (1) and the backing layer (2) or between the insulation layer (1) and the primer (3b) disposed on an underside of the backing layer (2), an adhesive (6) is applied comprising:
Natural rubber;
Rosin glycerol ester;
Linseed oil;
Casein;
Xanthan gum; and
Thiazoles.

12. The floor covering element according to claim 1, characterized in that for bonding between the insulation layer (1) and the backing layer (2) or between the insulation layer (1) and the primer (3b) disposed on an underside of the backing layer (2), as adhesive (6) a reactive hotmelt adhesive based on polyurethane, is applied.

13. The floor covering element according to claim 1, characterized in that the backing layer (2) is made of canvas of natural fiber vegetable fibers.

14. The floor covering element according to claim 1, characterized in that the backing layer (2) is made of canvas of mixed fibers comprising natural fibers and artificial fibers, with portions of polyesters and/or polyacrylonitrile.

15. The floor covering element according to claim 1, characterized in that the primer (3a, 3b) is designed as a coating comprising calcium carbonate and acrylic polymer comprising titanium white pigments.

16. The floor covering element according to claim 1, characterized in that the primer (3a, 3b) comprises titanium white pigments.

17. The floor covering element according to claim 1, characterized in that the sealing coat (5) comprises one of the following group: polyurethane-acrylate copolymer, a polyurethane, and a polyacrylate.

18. The floor covering element according to claim 1, characterized in that the backing layer (2) comprises canvas formed of silicate glass fibers.

19. The floor covering element according to claim 1, characterized in that for bonding between the insulation layer (1) and the backing layer (2) or between the insulation layer (1) and the primer (3b) disposed on an underside of the backing layer (2), an adhesive (6) is applied comprising a crosslinking system comprising a metal oxide consisting of at least one of the following group: zinc oxide, thiuram disulfide, and tetramethylthiuram disulfide.

20. The floor covering element according to claim 1, characterized in that for bonding between the insulation layer (1) and the backing layer (2) or between the insulation layer (1) and the aid primer (3b) disposed on an underside of the backing layer (2), an adhesive (6) is applied comprising:
rubber;
an ammonia stabilizer consisting of 0.1-0.5 wt. % ammonia; and
a crosslinking system consisting of a fatty acid.
